(19) United States
(12) Patent Application Publication
(10) Pub. No.: US 2026/0288155 A1
(43) Pub. Date: Sep. 24, 2026

(54) AUTOMATIC GUIDED VEHICLE AND STORAGE MEDIUM

(71) Applicant: DENSO CORPORATION, Kariya-city (JP)

(72) Inventors: Mizuki KOBAYASHI, Kariya-city (JP); Kiyoshi FUJII, Kariya-city (JP); Kazuki MARUO, Kariya-city (JP); Seiichi MURAKAMI, Kariya-city (JP); Yoshinori AKITSU, Kariya-city (JP); Go ENDOH, Kariya-city (JP); Akira TAKESAKI, Kariya-city (JP)

(21) Appl. No.: 19/689,138

(22) Filed: May 27, 2026

Related U.S. Application Data
(63) Continuation of application No. PCT/JP2024/041218, filed on Nov. 21, 2024.

(30) Foreign Application Priority Data
Dec. 19, 2023 (JP) 2023-213587

(51) Int. Cl. G05D 1/646; G05D 1/244; G05D 107/70; G05D 109/10

(52) U.S. Cl. CPC G05D 1/646; G05D 1/244; G05D 2107/70; G05D 2109/10

(57) ABSTRACT

An automatic guided vehicle is equipped with magnetic sensors arranged in a lateral direction, and travels along a strip-shaped magnetic line based on detection results of the magnetic line by the magnetic sensors. A range acquisition unit acquires a detection range in which the magnetic sensors that have detected the magnetic line are continuous. When there are multiple detection ranges acquired by the range acquisition unit in case where the automatic guided vehicle is instructed to travel straight, a range selection unit selects one detection range that is predicted to correspond to a magnetic line extending in a straight-ahead direction of the automatic guided vehicle. A travel control unit controls a driving state of the automatic guided vehicle so that a center of the one detection range in the lateral direction is brought closer to a center of the automatic guided vehicle in the lateral direction.

### CROSS REFERENCE TO RELATED APPLICATION

The present application is a continuation application of International Patent Application No. PCT/JP2024/041218 filed on Nov. 21, 2024, which designated the U.S. and claims the benefit of priority from Japanese Patent Application No. 2023-213587, filed on Dec. 19, 2023. The entire disclosures of all of the above applications are incorporated herein by reference.

### TECHNICAL FIELD

The present disclosure relates to an automatic guided vehicle guided by a magnetic line.

### BACKGROUND

An automatic guided vehicle has multiple magnetic sensors arranged in the lateral direction. The magnetic sensors are set so that only the magnetic sensor located directly above the magnetic tape is turned on.

### SUMMARY

According to an aspect of the present disclosure, an automatic guided vehicle includes plural magnetic sensors arranged in a lateral direction, and travels along a strip-shaped magnetic line on a travel path based on detection results of the magnetic line by the magnetic sensors. The automatic guided vehicle may include at least one of (i) a circuit and (ii) a processor with a memory storing computer program code executable by the processor, the at least one of the circuit and the processor configured to cause the automatic guided vehicle to: acquire a detection range in which the magnetic sensors that have detected the magnetic line are continuous; select one detection range predicted to correspond to the magnetic line extending in a straight-ahead direction of the automatic guided vehicle, among a plurality of detection ranges acquired when the automatic guided vehicle is instructed to travel straight; and control a driving state of the automatic guided vehicle so that a center of the one detection range in the lateral direction is brought closer to a center of the automatic guided vehicle in the lateral direction.

### BRIEF DESCRIPTION OF DRAWINGS

The features and advantages of the present disclosure will become more apparent from the following detailed description made with reference to the accompanying drawings:

FIG. 1 is a schematic diagram showing a side view of an automatic guided vehicle;

FIG. 2 is a schematic diagram showing a front of the automatic guided vehicle;

FIG. 3 is a schematic diagram showing a traveling state of the automatic guided vehicle straightly entering a crossroad of magnetic lines while instructed to travel straight;

FIG. 4 is a schematic diagram showing ON state of magnetic sensors at ta and tc in FIG. 3;

FIG. 5 is a schematic diagram showing ON state of magnetic sensors at tb in FIG. 3;

FIG. 6 is a schematic diagram of a comparative example showing a traveling state of an automatic guided vehicle obliquely entering a crossroad of magnetic lines while instructed to travel straight;

FIG. 7 is a schematic diagram showing ON state of magnetic sensors at tb in FIG. 6;

FIG. 8 is a block diagram showing a configuration of the automatic guided vehicle;

FIG. 9 is a flowchart showing control while instructed to travel straight;

FIG. 10 is a schematic diagram showing a positional relationship between an intersection of magnetic lines and a sensor unit of the automatic guided vehicle obliquely entering the intersection while instructed to travel straight;

FIG. 11 is a schematic diagram showing ON state of magnetic sensors at ta in FIG. 10;

FIG. 12 is a schematic diagram showing ON state of magnetic sensors at tb in FIG. 10;

FIG. 13 is a schematic diagram showing ON state of magnetic sensors in a modified example;

FIG. 14 is a schematic diagram showing ON state of magnetic sensors in another modified example;

FIG. 15 is a schematic diagram showing a positional relationship between a T-junction of magnetic lines and a sensor unit of the automatic guided vehicle obliquely entering the T-junction while instructed to travel straight;

FIG. 16 is a schematic diagram showing a positional relationship between a diagonal four-way intersection of magnetic lines and a sensor unit of the automatic guided vehicle obliquely entering the diagonal four-way intersection while instructed to travel straight;

FIG. 17 is a schematic diagram showing a positional relationship between a diagonal three-way intersection of magnetic lines and a sensor unit of the automatic guided vehicle obliquely entering the diagonal three-way intersection while instructed to travel straight;

FIG. 18 is a schematic diagram showing a positional relationship between a four-way intersection of magnetic lines and a sensor unit of the automatic guided vehicle obliquely entering the four-way intersection while instructed to travel straight;

FIG. 19 is a schematic diagram showing ON state of magnetic sensors at tb in FIG. 18;

FIG. 20 is a schematic diagram showing a side view of an automatic guided vehicle in a modified example; and

FIG. 21 is a flowchart showing control while instructed to travel straight in a modified example.

### DETAILED DESCRIPTION

An automatic guided vehicle has multiple magnetic sensors arranged in the lateral direction. The magnetic sensors are set so that only the magnetic sensor located directly above the magnetic tape is turned on. An ON range of the magnetic sensors that are turned on is detected and a signal indicating the center of the ON range is output. In the automatic guided vehicle, the rotational speeds of the left and right driving wheels are controlled so that the center of the ON range coincides with the center of the automatic guided vehicle in the lateral direction when traveling straight.

However, the inventors discovered that the following issues are to be solved when an automatic guided vehicle approaches a crossroad of magnetic tapes (magnetic lines) at a slight angle, while being instructed to travel straight. That is, the magnetic sensor near the center detects the magnetic tape extending in the straight direction and turns on, and the magnetic sensor near the end detects the magnetic tape extending in the left-right direction and turns on. In this case, the travel direction of the automatic guided vehicle will change toward the magnetic sensor near the end, since the center of the entire range, which is the combination of the ON range near the center, the ON range near the end, and the range between them, coincides with the center of the automatic guided vehicle in the left-right direction. As a result, the automatic guided vehicle may not travel along a straight line, but may turn along the magnetic tape extending in the left-right direction.

This situation is not limited to the crossing of the magnetic tapes, but is generally common to any path where a magnetic tape extending in a straight direction crosses another magnetic tape.

The present disclosure provides an automatic guided vehicle that can travel straight as instructed even on a road where a magnetic line extending in a straight direction intersects with another magnetic line.

According to a first aspect of the present disclosure, an automatic guided vehicle includes plural magnetic sensors arranged in a lateral direction, and travels along a strip-shaped magnetic line provided on a travel path based on detection results of the magnetic line by the magnetic sensors. The automatic guided vehicle includes: a range acquisition unit configured to acquire a detection range, within which the magnetic sensors that have detected the magnetic line are continuous; a range selection unit configured to select one detection range predicted to correspond to the magnetic line extending in the straight-ahead direction of the automatic guided vehicle among multiple detection ranges acquired by the range acquisition unit when the automatic guided vehicle is instructed to travel straight; and a travel control unit configured to control a driving state of the automatic guided vehicle so that a center of the one detection range selected by the range selection unit in the lateral direction is brought closer to a center of the automatic guided vehicle in the lateral direction.

Accordingly, the automatic guided vehicle is equipped with the magnetic sensors arranged in the lateral direction, and travels along a strip-shaped magnetic line provided on the roadway based on the results of detection of the magnetic line by the magnetic sensors.

The range acquisition unit acquires the detection range, in which the magnetic sensors that have detected the magnetic line are continuous. When there are multiple magnetic sensors that have detected the magnetic line and the magnetic sensors are not contiguous (separate from each other), the magnetic sensors are acquired as separate detection ranges. The detection range of only one of the magnetic sensors that have detected the magnetic line is also acquired. That is, the detection range does not necessarily have to include multiple magnetic sensors.

When there are multiple detection ranges acquired by the range acquisition unit in case where the automatic guided vehicle is instructed to go straight, the range selection unit selects one detection range that is predicted to correspond to the magnetic line extending in the straight-ahead direction of the automatic guided vehicle. Therefore, when a magnetic line extending in the straight-ahead direction intersects with another magnetic line, it is possible to predict and select one detection range that corresponds to the magnetic line extending in the straight-ahead direction of the automatic guided vehicle, instead of the entire detection range combining the multiple detection ranges and the range between them, as the detection range.

The travel control unit controls the driving state of the automatic guided vehicle so that the center of the one detection range selected by the range selection unit in the lateral direction is brought closer to the center of the automatic guided vehicle in the lateral direction. Therefore, even on a road where a magnetic line extending in the straight-ahead direction intersects with another magnetic line, the automatic guided vehicle can bring the center of the magnetic line extending in the straight-ahead direction in the lateral direction closer to the center of the automatic guided vehicle in the lateral direction, allowing it to travel straight as instructed.

According to a second aspect of the present disclosure, a control program is applied to an automatic guided vehicle that includes magnetic sensors arranged in a lateral direction and travels along a strip-shaped magnetic line provided on a roadway based on detection results of the strip-shaped magnetic line by the magnetic sensors. The control program includes instructions to cause a computer to: acquire a detection range, in which the magnetic sensors that have detected the magnetic line are continuous; select one detection range predicted to correspond to the magnetic line extending in the straight-ahead direction of the automatic guided vehicle when plural detection ranges are acquired while the automatic guided vehicle is instructed to travel straight; and control a traveling state of the automatic guided vehicle so that a center, in the lateral direction, of the selected one detection range is brought closer to a center of the automatic guided vehicle.

Accordingly, it is possible to achieve the same effects as those of the first aspect by causing the computer to execute the control program applied to the automatic guided vehicle.

Hereinafter, an embodiment will be described with reference to the drawings, regarding an automatic guided vehicle (AGV) guided by a magnetic tape (magnetic line) in a factory, warehouse, or the like. The automatic guided vehicle is, for example, an unmanned transport vehicle or an unmanned transport robot.

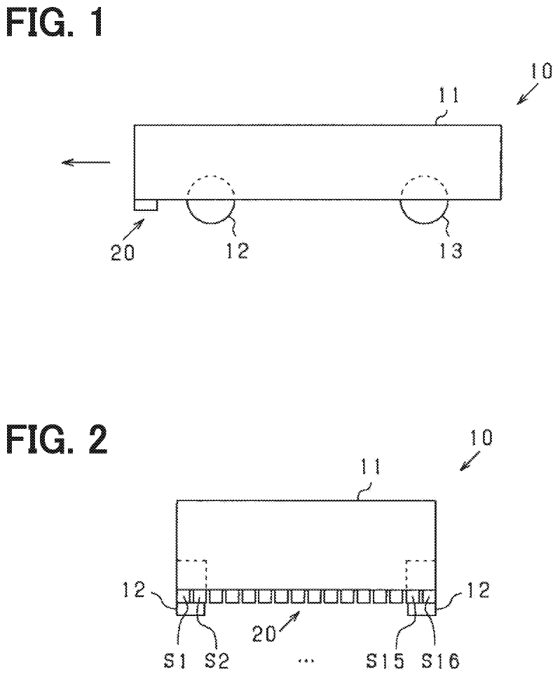

As shown in FIG. 1, an automatic guided vehicle 10 includes a main body 11, drive wheels 12, driven wheels 13, and a sensor unit 20.

The main body 11 has, for example, a hollow rectangular parallelepiped shape. Inside the main body 11, a motor (not shown) is provided for rotating the drive wheel 12. The travel direction (driving state) of the automatic guided vehicle 10 is controlled by creating a difference between the rotational speed at which the motor rotates the left drive wheel 12 and the rotational speed at which the motor rotates the right drive wheel 12. A front wheel of the automatic guided vehicle 10 is, for example, the drive wheel 12, and a rear wheel of the automatic guided vehicle 10 is the driven wheel 13. In other words, the automatic guided vehicle 10 is a front-wheel drive vehicle. The driven wheels 13 rotate as the automatic guided vehicle 10 moves.

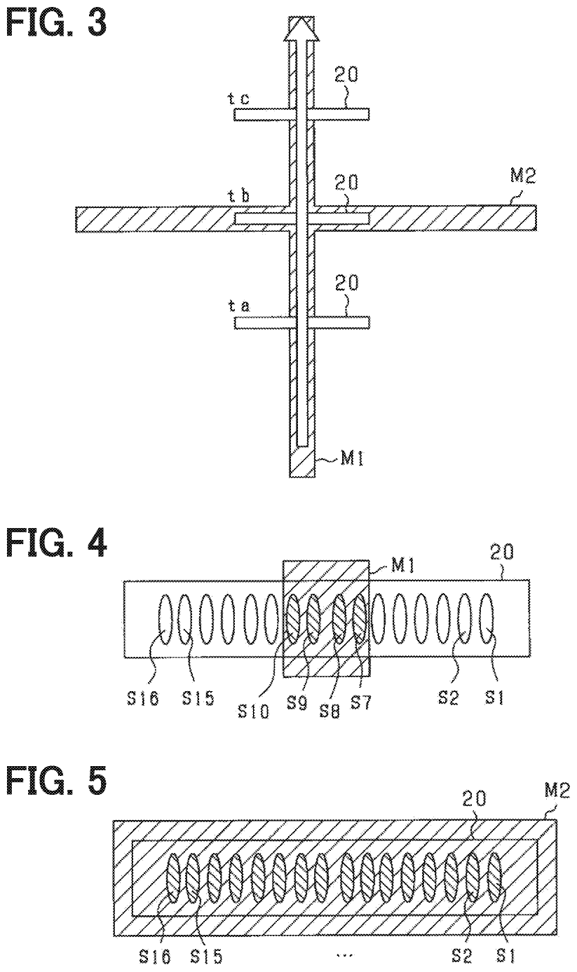

The sensor unit 20 is attached to the bottom of the front part of the main body 11. As shown in FIG. 2, the sensor unit 20 includes, for example, 16 magnetic sensors S1 to S16. The magnetic sensors S1 to S16 are arranged horizontally in a direction perpendicular to the straight-ahead direction of the automatic guided vehicle 10. That is, the magnetic sensors S1 to S16 are arranged in the lateral (left-right) direction of the automatic guided vehicle 10 perpendicular to the longitudinal direction of the automatic guided vehicle 10. The magnetic sensors S1 to S16 are arranged at equal intervals from the right end to the left end of the automatic guided vehicle 10. Each of the magnetic sensors S1 to S16 is turned on when the magnetic tape M1, M2 (see FIGS. 3 and 4) is present directly below the magnetic sensor S1 to S16, and turned off when the magnetic tape M1, M2 is not present directly below the magnetic sensor S1 to S16. That is, the magnetic sensor S1 to S16 is configured to detect only the magnetic tape M1, M2 directly below the magnetic sensor.

FIG. 3 is a schematic diagram showing the traveling state of the automatic guided vehicle 10 that has entered straight ahead the intersection of the magnetic tapes M1 and M2 when instructed to go straight ahead. The strip-shaped magnetic tape M1 and the strip-shaped magnetic tape M2 are attached on the roadway of the automatic guided vehicle 10. The strip-shaped magnetic tape M1 extends linearly in the straight-ahead direction. The strip-shaped magnetic tape M2 extends linearly in the left-right direction perpendicular to the magnetic tape M1. The automatic guided vehicle 10 moves straight along the magnetic tape M1 as instructed.

As shown in FIG. 4, the positions of the magnetic sensors S1 to S16 in the left-right direction are referred to as Positions 1 to 16, respectively. The center position of the magnetic sensors S1 to S16 in the left-right direction is a center between Position 8 of the magnetic sensor S8 and Position 9 of the magnetic sensor S9. Therefore, the center position of the magnetic sensors S1 to S16 in the left-right direction is represented by Center Position 8.5. The center position of the automatic guided vehicle 10 in the left-right direction and Center Position 8.5 of the sensor unit 20 in the left-right direction coincide with each other.

When the sensor unit 20 is at “ta” or “tc” in FIG. 3, the magnetic sensors S7-S10 are turned on, for example, as shown in FIG. 4. The ta, tb or tc represents not only position but also time. In this case, the detection range, which is a range in which the magnetic sensors that have detected the magnetic tape M1 are continuous, is defined as Detection Range S7-S10. The center of Detection Range S7-S10 is Center Position 8.5. When the automatic guided vehicle 10 is instructed to go straight, the automatic guided vehicle 10 controls each drive wheel 12 of the automatic guided vehicle 10 so that the center of Detection Range S7-S10 (Position 8.5 in FIG. 4) coincides with (approaches) the center of the automatic guided vehicle 10 (Center Position 8.5). Therefore, when the sensor unit 20 is at “ta” or “tc” in FIG. 3, the automatic guided vehicle 10 moves straight along the magnetic tape M1.

When the sensor unit 20 is at the position “tb” in FIG. 3, the magnetic sensors S1 to S16 are turned on, for example, as shown in FIG. 5. In this case, the detection range in which the magnetic sensors that have detected the magnetic tape M1, M2 are continuous is Detection Range S1-S16. The center of Detection Range S1-S16 is Position 8.5. When the automatic guided vehicle 10 is instructed to go straight, the automatic guided vehicle 10 controls each drive wheel 12 of the automatic guided vehicle 10 so that the center of Detection Range S1-S16 in the left-right direction (Position 8.5 in FIG. 5) coincides with the center of the automatic guided vehicle 10 in the left-right direction (Center Position 8.5). Therefore, even when the sensor unit 20 is at the position tb in FIG. 3, the automatic guided vehicle 10 moves straight along the magnetic tape M1.

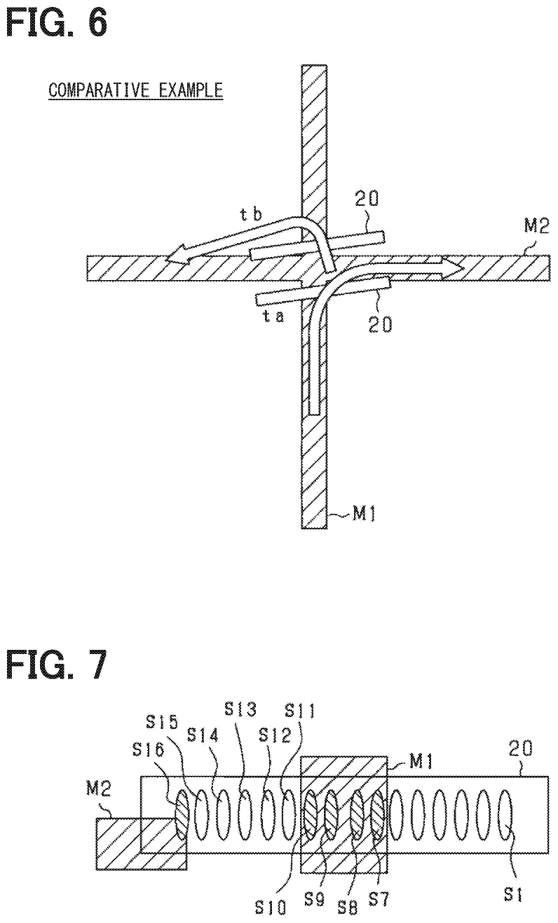

FIG. 6 is a schematic diagram of a comparative example showing a traveling state of an automatic guided vehicle that obliquely enters the intersection of the magnetic tapes M1, M2 while instructed to go straight. The automatic guided vehicle turns right or left along the magnetic tape M2.

When the sensor unit 20 is at the position tb in FIG. 6, for example, as shown in FIG. 7, the magnetic sensors S7 to S10 and S16 are turned on. In this case, the detection range, in which the magnetic sensors that detected the magnetic tape M1 are continuous, is Detection Range S7-S10. The detection range, in which the magnetic sensors that detected the magnetic tape M2 are continuous, is Detection Range S16. The center of Detection Range S7-S10 is Position 8.5. The center of Detection range S16 is Position 16. In the comparative example, when the automatic guided vehicle is instructed to go straight, the drive wheels 12 of the automatic guided vehicle 10 are controlled so that the center of the entire range S7-S16 (Position 11.5 in FIG. 7), which is the combination of Detection Range S7-S10, Detection Range S16, and Range S11-S15 between the Detection Ranges, coincides with the center of the automatic guided vehicle 10 in the left-right direction (Center Position 8.5). Therefore, when the sensor unit 20 is at the position tb in FIG. 6, the automatic guided vehicle 10 turns left and travels along the magnetic tape M2. When the sensor unit 20 is at the position ta in FIG. 6, the automatic guided vehicle 10 turns right and travels along the magnetic tape M2.

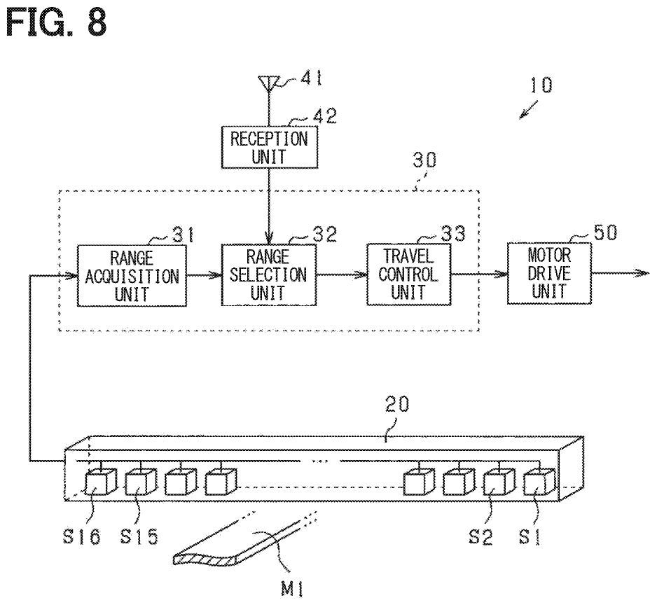

In contrast, according to the embodiment, as shown in FIG. 8, the automatic guided vehicle 10 is equipped with a range acquisition unit 31, a range selection unit 32, a travel control unit 33, an antenna 41, a reception unit 42, and a motor drive unit 50.

The reception unit 42 is configured by, for example, a communication module. The reception unit 42 receives, via the antenna 41, instructions such as a straight-ahead instruction, a right-turn instruction, and a left-turn instruction from a management device (not shown). The reception unit 42 inputs the received instructions such as straight-ahead instruction, right-turn instruction, and left-turn instruction to the range selection unit 32.

The range acquisition unit 31, the range selection unit 32, and the travel control unit 33 are configured by a microcomputer 30 including, for example, a CPU, a ROM, a RAM, an input/output interface, and the like. The microcomputer 30 (computer) executes the installed control program to realize the functions of the range acquisition unit 31, the range selection unit 32, the travel control unit 33, and the like. The microcomputer 30 can transmit and receive data wirelessly via the antenna 41 and the reception unit 42 using, for example, OTA (Over The Air) technology, and can update software (programs).

The range acquisition unit 31 receives a signal indicating which magnetic sensors are turned on from the sensor unit 20. Based on the signal input from the sensor unit 20, the range acquisition unit 31 acquires a detection range, which is a range in which the magnetic sensors that detected the magnetic tape M1, M2 are continuous. When there is only one detection range acquired by the range acquisition unit 31 in case where the automatic guided vehicle 10 is instructed to go straight, the range selection unit 32 selects the only one detection range. When there are multiple detection ranges acquired by the range acquisition unit 31 in case where the automatic guided vehicle 10 is instructed to go straight, the range selection unit 32 selects one detection range that is closest to the center of the automatic guided vehicle 10 in the left-right direction. When the automatic guided vehicle 10 is instructed to turn right, the range selection unit 32 selects, as the detection range, one magnetic sensor that is closest to the right end of the automatic guided vehicle 10 from among the magnetic sensors that are turned on. When the automatic guided vehicle 10 is instructed to turn left, the range selection unit 32 selects, as the detection range, one magnetic sensor that is closest to the left end of the automatic guided vehicle 10 from among the magnetic sensors that are turned on. Thereafter, the instruction to the automatic guided vehicle 10 is switched to an instruction to go straight.

The travel control unit 33 sets the drive amount of each motor so that the center of the one detection range selected by the range selection unit 32 in the left-right direction coincides (approaches) with the center of the automatic guided vehicle 10 (Center Position 8.5) in the left-right direction. That is, the travel control unit 33 controls the travel direction (driving state) of the automatic guided vehicle 10.

The motor drive unit 50 includes, for example, a power supply and a drive circuit (not shown). The motor drive unit 50 drives each motor that rotates each drive wheel 12 based on the drive amount set by the travel control unit 33. As a result, the automatic guided vehicle 10 travels along the magnetic tape M1 or the magnetic tape M2 in accordance with instructions from a management device or the like.

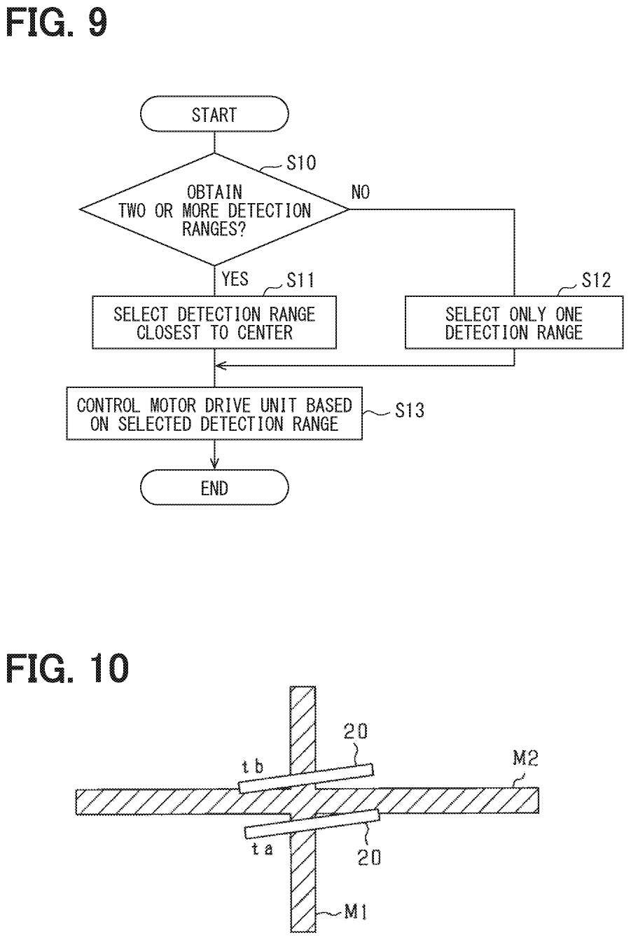

FIG. 9 is a flowchart showing a control when a straight-ahead instruction is given. This series of processes is repeatedly executed by the microcomputer 30 at a predetermined interval when the automatic guided vehicle 10 is instructed to go straight by a management device or the like.

First, it is determined whether two or more detection ranges have been acquired (S10). In this determination, when it is determined that two or more detection ranges have been acquired (S10: YES), the detection range closest to the center of the automatic guided vehicle 10 is selected (S11). When it is determined that two or more detection ranges have not been acquired (S10: NO), the only one detection range is selected (S12).

Next, the motor drive unit 50 is controlled based on the selected detection range (S13). Specifically, the drive amount of each motor is set so that the center of the one detection range in the left-right direction coincides with the center of the automatic guided vehicle 10 (Center Position 8.5) in the left-right direction. Then, the series of processing described above is terminated (END). Then, the motor drive unit 50 drives each motor based on the set driving amount.

The process of S10 corresponds to a process performed by the range acquisition unit 31. The processes of S11 and S12 correspond to a process performed by the range selection unit 32. The process of S13 corresponds to a process performed by the travel control unit 33.

FIG. 10 is a schematic diagram showing a positional relationship between the intersection of the magnetic tapes M1 and M2 and the sensor unit 20 of the automatic guided vehicle 10 that obliquely enters the intersection while instructed to go straight.

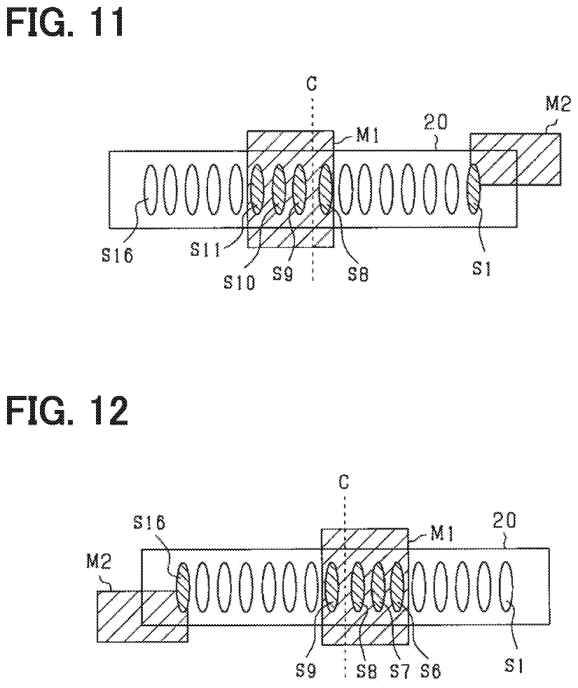

When the automatic guided vehicle 10 is traveling straight along the magnetic tape M1 and obliquely enters the intersection of the magnetic tapes M1 and M2 (time ta), the range acquisition unit 31 may acquire multiple detection ranges (see FIG. 11). In this case, of Detection Range S1 and Detection Range S8-S11 acquired by the range acquisition unit 31, Detection Range S8-S11 closest to Center Position 8.5 in the left-right direction of the automatic guided vehicle 10 is likely to be the detection range acquired by the range acquisition unit 31 before entering the intersection. A dashed line C indicates Center Position 8.5 of the automatic guided vehicle 10 and the sensor unit 20.

When the sensor unit 20 is at the position ta in FIG. 10, for example, as shown in FIG. 11, the magnetic sensors S1, S8 to S11 are turned on. In this case, the detection range, in which the magnetic sensors that detected the magnetic tape M2 are continuous, is Detection Range S1. The center of Detection Range S1 is Position 1. The detection range, in which the magnetic sensors that detected the magnetic tape M1 are continuous, is Detection Range S8-S11. The center of Detection Range S8-S11 is Position 9.5. Therefore, the range selection unit 32 selects Detection Range S8-S11 that are closest to Center Position 8.5 in the left-right direction of the automatic guided vehicle 10. In other words, when there are multiple detection ranges acquired by the range acquisition unit 31 in case where the automatic guided vehicle 10 is instructed to go straight, the range selection unit 32 selects one detection range that is predicted to correspond to the magnetic tape M1 extending in the straight-ahead direction of the automatic guided vehicle 10.

The travel control unit 33 controls each drive wheel 12 of the automatic guided vehicle 10 so that the center of Detection Range S8-S11 in the left-right direction (Position 9.5 in FIG. 11) coincides with Center Position 8.5 in the left-right direction of the automatic guided vehicle 10. As a result, the travel direction of the automatic guided vehicle 10 is corrected to the left. As a result, the automatic guided vehicle 10 moves straight along the magnetic tape M1.

When the sensor unit 20 is at the position tb in FIG. 10, the magnetic sensors S6 to S9 and S16 are turned on, as shown in FIG. 12. In this case, the detection range, in which the magnetic sensors that detected the magnetic tape M2 are continuous, is Detection Range S16. The center of Detection Range S16 is Position 16. The detection range, in which the magnetic sensors that detected the magnetic tape M1 are continuous, is Detection Range S6-S9. The center of Detection Range S6-S9 is Position 7.5. Therefore, the range selection unit 32 selects Detection Range S6-S9 that are closest to Center Position 8.5 in the left-right direction of the automatic guided vehicle 10. Then, the travel control unit 33 controls each drive wheel 12 of the automatic guided vehicle 10 so that the center of Detection Range S6-S9 in the left-right direction (Position 7.5 in FIG. 12) coincides with Center Position 8.5 in the left-right direction of the automatic guided vehicle 10. As a result, the travel direction of the automatic guided vehicle 10 is corrected to the right. As a result, the automatic guided vehicle 10 moves straight along the magnetic tape M1.

The present embodiment has the following advantages.

The range acquisition unit 31 acquires a detection range, in which the magnetic sensors that detected the magnetic tape M1, M2 are continuous. Therefore, as shown in FIG. 11, when the magnetic sensors S1, S8 to S11 are present and detect the magnetic tape M1, M2, and the magnetic sensor S1 and the magnetic sensors S8 to S11 are not continuous (separate from each other), the magnetic sensor S1 and the magnetic sensors S8 to S11 are acquired as Detection Range S1 and Detection Range S8-S11 separate from each other.

As shown in FIG. 11, when there are multiple detection ranges acquired by the range acquisition unit 31 in case where the automatic guided vehicle 10 is instructed to go straight, the range selection unit 32 selects one detection range S8-S11 that is predicted to correspond to the magnetic tape M1 extending in the straight-ahead direction of the automatic guided vehicle 10. Therefore, when another magnetic tape M2 intersects with the magnetic tape M1 extending in the straight-ahead direction, it is possible to predict and select one detection range S8-S11 that corresponds to the magnetic tape M1 extending in the straight-ahead direction of the automatic guided vehicle 10, instead of the entire range that combines the multiple detection ranges and the range between them as the detection range.

The travel control unit 33 controls the driving state of the automatic guided vehicle 10 so that the center of the one detection range selected by the range selection unit 32 is brought closer to Center Position 8.5 in the lateral direction of the automatic guided vehicle 10. Therefore, even on a driving path where another magnetic tape M2 intersects with the magnetic tape M1 extending in the straight-ahead direction, the automatic guided vehicle 10 can bring Center Position 8.5 in the lateral direction of the automatic guided vehicle 10 closer to the center of the magnetic tape M1 extending in the straight-ahead direction, so as to travel straight as instructed.

The range selection unit 32 selects, from the multiple detection ranges acquired by the range acquisition unit 31 when the automatic guided vehicle 10 is instructed to travel straight, the one detection range that is closest to Center Position 8.5 in the left-right direction of the automatic guided vehicle 10 as the one detection range that is predicted to correspond to the magnetic tape M1 extending in the straight-ahead direction. With this configuration, when the automatic guided vehicle 10 is instructed to go straight and there are multiple detection ranges acquired by the range acquisition unit 31, it is highly possible to select one detection range corresponding to the magnetic tape M1 extending in the straight-ahead direction of the automatic guided vehicle 10.

When the automatic guided vehicle 10 is instructed to go straight and there is only one detection range acquired by the range acquisition unit 31, the range selection unit 32 selects the only one detection range. With this configuration, even if there is only one detection range acquired by the range acquisition unit 31 while the automatic guided vehicle 10 is instructed to go straight, it is possible to select a detection range. Therefore, the travel control unit 33 can perform control in the same manner as there are multiple detection ranges.

The above-mentioned effects can be achieved by having the microcomputer 30 execute the control program applied to the automatic guided vehicle 10.

The embodiment may be modified in the following manners. The same parts as those in the embodiment are denoted by the same reference numerals and the description thereof will be referenced.

When the automatic guided vehicle 10 is traveling straight and approaches the intersection of the magnetic tapes M1 and M2 obliquely (at a slight angle), as shown in FIG. 11, the range acquisition unit 31 may acquire a new detection range S1 in addition to the detection range S8-S11 that were acquired by the range acquisition unit 31 before the automatic guided vehicle 10 entered the intersection. In this case, the detection range S1 newly acquired by the range acquisition unit 31 is likely to be initially narrower than the detection range S8-S11 acquired by the range acquisition unit 31 before entering the intersection. Therefore, of the detection range S1 and the detection range S8-S11 acquired by the range acquisition unit 31, the detection range S8-S11, which has the widest range, is relatively likely to be the detection range acquired by the range acquisition unit 31 before entering the intersection.

Therefore, as shown in FIG. 11, for example, the range selection unit 32 may select one detection range S8-S11, which is closest to Center Position 8.5 in the left-right direction of the automatic guided vehicle 10 and has the widest range, from the multiple detection ranges acquired by the range acquisition unit 31 when the automatic guided vehicle 10 is instructed to go straight, as one detection range predicted to correspond to the magnetic tape M1 extending in the straight-line direction. With this configuration, when the automatic guided vehicle 10 is instructed to go straight and there are multiple detection ranges acquired by the range acquisition unit 31, it is possible to select the detection range S8-S11 that meet two requirements that make it highly likely that the detection range was acquired by the range acquisition unit 31 before entering the intersection. Therefore, it is possible to select one detection range corresponding to the magnetic tape M1 extending in the straight direction of the automatic guided vehicle 10 with an even higher probability.

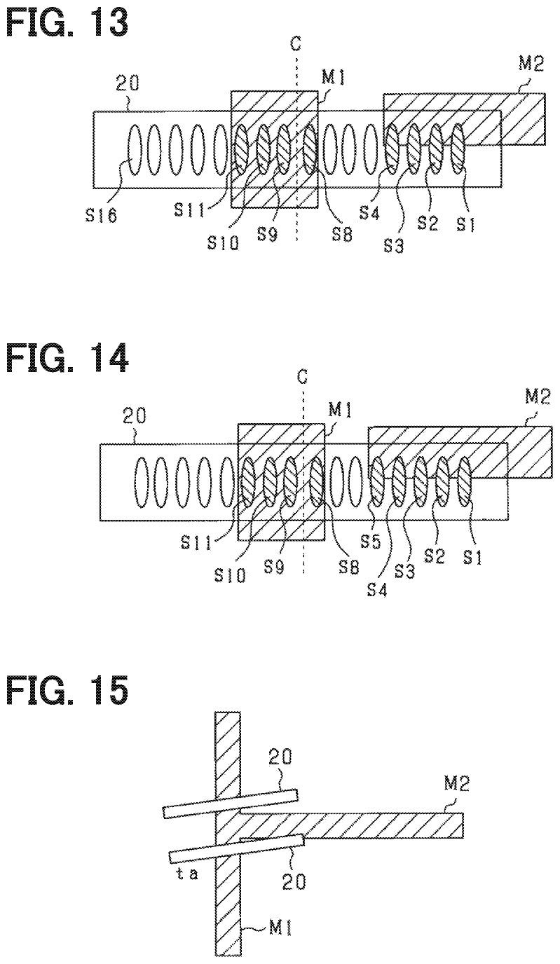

As shown in FIG. 13, among the multiple detection ranges acquired by the range acquisition unit 31 when the automatic guided vehicle 10 is instructed to go straight, there may be multiple detection ranges that are the widest. In FIG. 13, the detection range S1-S4 and the detection range S8-S11 have the same width. In this case, the range selection unit 32 selects one detection range S8-S11, which is closest to Center Position 8.5 in the left-right direction of the automatic guided vehicle 10, from the multiple detection ranges acquired by the range acquisition unit 31 when the automatic guided vehicle 10 is instructed to go straight, as the one detection range predicted to correspond to the magnetic tape M1 extending in the straight-ahead direction.

As shown in FIG. 14, among the multiple detection ranges acquired by the range acquisition unit 31 when the automatic guided vehicle 10 is instructed to go straight, it is possible that one detection range S8-S11 that is closest to Center Position 8.5 in the left-right direction of the automatic guided vehicle 10 is different from one detection range S1-S5 that has the widest range. When the one detection range S8-S11 closest to Center Position 8.5 in the left-right direction of the automatic guided vehicle 10 is different from the one detection range S1-S5 with the widest range, among the multiple detection ranges acquired by the range acquisition unit 31 when the automatic guided vehicle 10 is instructed to go straight, the range selection unit 32 selects the one detection range S8-S11 closest to Center Position 8.5 in the left-right direction of the automatic guided vehicle 10 as the one detection range predicted to correspond to the magnetic tape M1 extending in the straight direction. With this configuration, even if the one detection range S8-S11 closest to Center Position 8.5 in the left-right direction of the automatic guided vehicle 10 is different from the one detection range S1-S5 with the widest range, it is possible to select the one detection range S8-S11 that is more likely to be the detection range acquired by the range acquisition unit 31 before entering the intersection.

As shown in FIG. 11, among the multiple detection ranges acquired by the range acquisition unit 31 when the automatic guided vehicle 10 is instructed to go straight, the detection range S8-S11 closest to Center Position 8.5 in the left-right direction of the automatic guided vehicle 10 often coincides with the one detection range S8-S11 with the widest range. There is a relatively high possibility that the widest detection range S8-S11 is the detection range that was acquired by the range acquisition unit 31 before entering the intersection. Therefore, the range selection unit 32 may select the widest detection range S8-S11 from the detection range S1 and the detection range S8-S11 acquired by the range acquisition unit 31 when the automatic guided vehicle 10 is instructed to travel straight as the detection range predicted to correspond to the magnetic tape M1 extending in the straight-ahead direction. Even with this configuration, when the automatic guided vehicle 10 is instructed to go straight and there are multiple detection ranges acquired by the range acquisition unit 31, it is possible to select the one detection range S8-S11 corresponding to the magnetic tape M1 extending in the straight-ahead direction of the automatic guided vehicle 10 with a relatively high probability.

FIG. 15 is a schematic diagram showing a positional relationship between a T-junction marked by magnetic tapes M1 and M2 and the sensor unit 20 of the automatic guided vehicle 10 obliquely entering the T-junction while instructed to go straight. In this case as well, when the sensor unit 20 is at the position ta in FIG. 15, the magnetic sensors S1, S8 to S11 are turned on, as shown in FIG. 11. The automatic guided vehicle 10 can travel straight as instructed by applying the above embodiment and each of the modified examples.

FIG. 16 is a schematic diagram showing a positional relationship between a diagonal intersection of the magnetic tapes M1 and M2 and the sensor unit 20 of the automatic guided vehicle 10 obliquely entering the diagonal intersection while instructed to go straight. In this case, when the sensor unit 20 is at the position ta in FIG. 16, the magnetic sensors S1 to S4 and S8 to S11 are turned on, for example, as shown in FIG. 13. When the sensor unit 20 is at the position tb in FIG. 16, the magnetic sensors S6 to S9 and S16 are turned on, for example, as shown in FIG. 12. The automatic guided vehicle 10 can travel straight as instructed by applying the above embodiment and each of the modified examples.

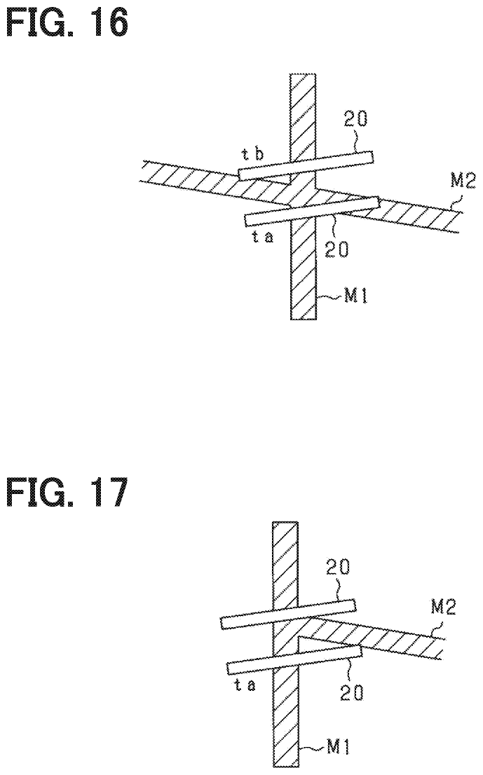

FIG. 17 is a schematic diagram showing a positional relationship between a diagonal three-way intersection marked by the magnetic tapes M1 and M2 and the sensor unit 20 of the automatic guided vehicle 10 obliquely entering the diagonal three-way intersection while instructed to go straight. In this case as well, when the sensor unit 20 is at the position ta in FIG. 17, the magnetic sensors S1, S8 to S11 are turned on, for example, as shown in FIG. 11. The automatic guided vehicle 10 can travel straight as instructed by applying the above embodiment and each of the modified examples.

FIG. 18 is a schematic diagram showing a positional relationship between a four-way intersection marked by the magnetic tapes M1, M2, and M3 and the sensor unit 20 of the automatic guided vehicle 10 obliquely entering the four-way intersection while instructed to go straight. In this case, when the sensor unit 20 is at the position ta in FIG. 18, the range selection unit 32 selects the only one detection range. Then, the travel control unit 33 controls each drive wheel 12 of the automatic guided vehicle 10 so that the center of the selected detection range in the left-right direction coincides with Center Position 8.5 in the left-right direction of the automatic guided vehicle 10. Therefore, the automatic guided vehicle 10 can move straight along the magnetic tape M1.

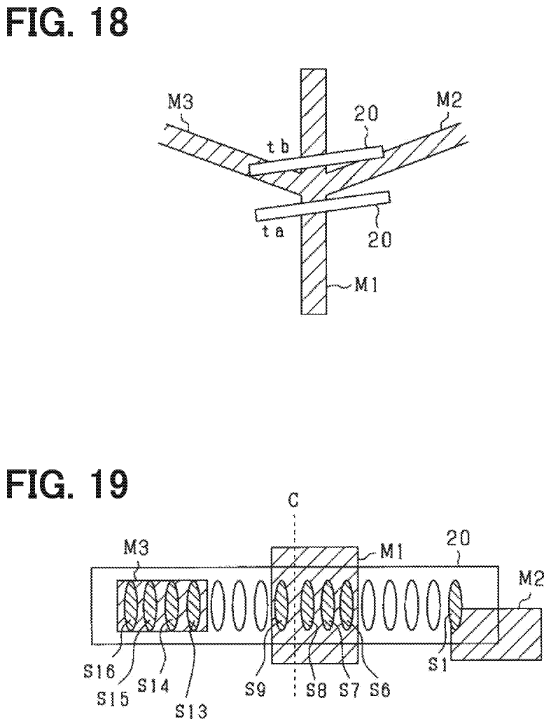

When the sensor unit 20 is at the position tb in FIG. 18, the magnetic sensors S1, S6 to S9, and S13 to S16 are turned on, for example, as shown in FIG. 19. In this case, the detection range S6-S9 corresponding to the magnetic tape M1 extending in the straight-ahead direction of the automatic guided vehicle 10 is the closest to Center Position 8.5 in the left-right direction of the automatic guided vehicle 10 and has the widest range among the multiple detection ranges acquired by the range acquisition unit 31. Therefore, the automatic guided vehicle 10 can travel straight as instructed by applying the above embodiment and each of the modified examples.

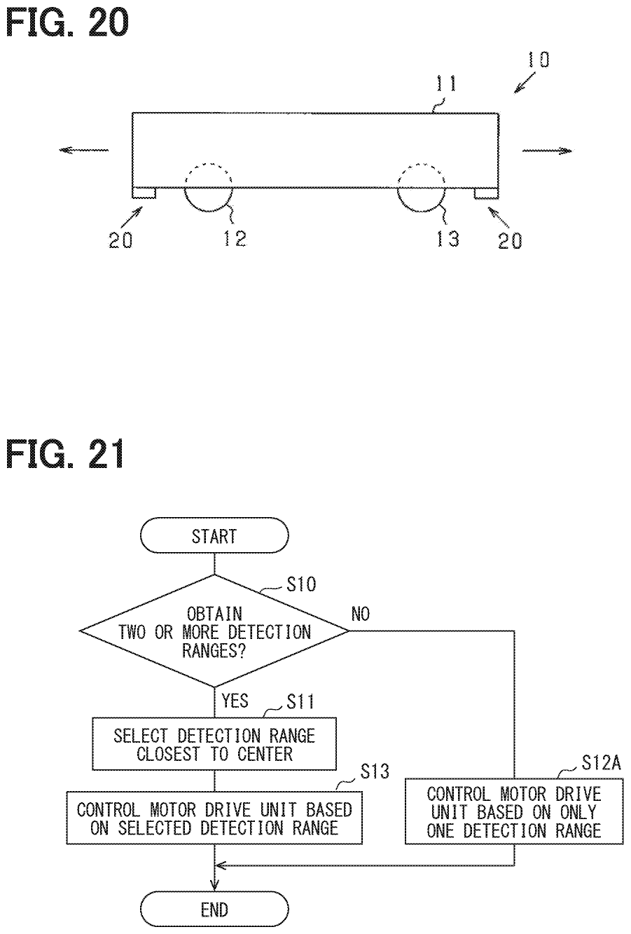

FIG. 20 is a schematic diagram showing a side view of a modified example of the automatic guided vehicle 10. In this modified example, the automatic guided vehicle 10 is equipped with two sensor units 20, one of which is attached to the bottom of the front of the main body 11 (one end in the front-rear direction), and the other of which is attached to the bottom of the rear of the main body 11 (the other end in the front-rear direction). In this case, the automatic guided vehicle 10 may detect the magnetic tapes M1 to M3 with the front sensor unit 20 when moving forward, and may detect the magnetic tapes M1 to M3 with the rear sensor unit 20 when moving backward. Even with this configuration, it is possible to achieve the same effects as those of the embodiment and each of the modifications.

FIG. 21 is a flowchart showing a modified example of the control when a straight-ahead command is issued. The same steps as those in FIG. 12 are denoted by the same step numbers S and the description thereof is referenced herein. In FIG. 21, when it is determined in S10 that two or more detection ranges have not been acquired (S10: NO), the motor drive unit 50 is controlled based on the only one detection range (S12A). Specifically, the motor drive unit 50 is controlled so that the center of the only one detection range coincides with the center of the automatic guided vehicle 10. With this configuration, the same effects as those of the embodiment can be achieved.

The travel control unit 33 may set the drive amount of each motor so that the deviation between the center of one detection range selected by the range selection unit 32 and the center of the automatic guided vehicle 10 (Center Position 8.5) in the left-right direction is smaller than a predetermined deviation. In other words, the travel control unit 33 simply sets the drive amount of each motor so that the center of one detection range selected by the range selection unit 32 is brought closer to the center of the automatic guided vehicle 10 in the lateral direction.

The driven wheels 13 of the automatic guided vehicle 10 can also be changed to steering wheels. In this case, the travel control unit 33 may set the operation amount of steering wheel so that the center of the one detection range selected by the range selection unit 32 coincides (approaches) with the center of the automatic guided vehicle 10 (Center Position 8.5) in the lateral direction. Then, the steered wheel may be operated by an actuator based on the set operation amount. Even with this configuration, the travel control unit 33 can control the travel direction (driving state) of the automatic guided vehicle 10. In addition, the travel control unit 33 may set the operation amount of steering wheel so that the deviation between the center of one detection range selected by the range selection unit 32 and the center of the automatic guided vehicle 10 in the lateral direction is smaller than a predetermined deviation. In other words, the travel control unit 33 simply sets the operation amount of steering wheel so that the center of one detection range selected by the range selection unit 32 approaches the center of the automatic guided vehicle 10 in the lateral direction.

The number of magnetic sensors included in the sensor unit 20 may be less than sixteen or more than sixteen.

The microcomputer 30 (the range acquisition unit 31, the range selection unit 32, and the travel control unit 33) and the method thereof described in the present disclosure may be realized by a dedicated computer provided by configuring a processor and memory programmed to execute one or more functions (instructions) embodied in a computer program. Alternatively, the microcomputer 30 and techniques described in this disclosure may be implemented in a special purpose computer provided by configuring the processor with one or more dedicated hardware logic circuits. Alternatively, the microcomputer 30 and the method described in the present disclosure may be implemented by one or more special purpose computer, which is configured as a combination of a processor and a memory, which are programmed to perform one or more functions, and a processor which is configured with one or more hardware logic circuits. Furthermore, the computer program may be stored on a computer-readable non-transitory tangible storage medium as instructions executed by a computer.

The embodiments and the modifications can be implemented in any combination within a possible range.

Although the present disclosure has been described in accordance with the embodiments, it is understood that the present disclosure is not limited to the embodiments and structures disclosed therein. The present disclosure encompasses various modifications and variations within the scope of equivalents. In addition, while the various combinations and configurations, which are preferred, other combinations and configurations, including more, less or only a single element, are also within the spirit and scope of the present disclosure.

What is claimed is:

1. An automatic guided vehicle configured to travel along a strip-shaped magnetic line on a travel path based on detection results of the magnetic line by a plurality of magnetic sensors provided on the automatic guided vehicle and arranged in a lateral direction comprising: at least one of (i) a circuit and (ii) a processor with a memory storing computer program code executable by the processor, the at least one of the circuit and the processor configured to cause the automatic guided vehicle to:
acquire a detection range in which the magnetic sensors that have detected the magnetic line are continuous;
select one detection range predicted to correspond to the magnetic line extending in a straight-ahead direction of the automatic guided vehicle, among a plurality of detection ranges acquired when the automatic guided vehicle is instructed to travel straight; and
control a driving state of the automatic guided vehicle so that a center of the one detection range in the lateral direction is brought closer to a center of the automatic guided vehicle in the lateral direction.

2. The automatic guided vehicle according to claim 1, wherein the at least one of the circuit and the processor is configured to cause the automatic guided vehicle to:
select, from among the plurality of detection ranges acquired when the automatic guided vehicle is instructed to travel straight, one detection range that is closest to the center of the automatic guided vehicle in the lateral direction as the one detection range.

3. The automatic guided vehicle according to claim 2, wherein the at least one of the circuit and the processor is configured to cause the automatic guided vehicle to:
select, from among the plurality of detection ranges acquired when the automatic guided vehicle is instructed to travel straight, one detection range that is closest to the center of the automatic guided vehicle in the lateral direction and has the widest range as the one detection range.

4. The automatic guided vehicle according to claim 3, wherein the at least one of the circuit and the processor is configured to cause the automatic guided vehicle to:
select, from among the plurality of detection ranges acquired when the automatic guided vehicle is instructed to travel straight, one detection range that is closest to the center of the automatic guided vehicle in the lateral direction as the one detection range, when the one detection range that is closest to the center of the automatic guided vehicle in the lateral direction is different from another one detection range having the widest range.

5. The automatic guided vehicle according to claim 1, wherein the at least one of the circuit and the processor is configured to cause the automatic guided vehicle to:
select, from among the plurality of detection ranges acquired when the automatic guided vehicle is instructed to travel straight, one detection range that has the widest range as the one detection range.

6. The automatic guided vehicle according to claim 1, wherein the at least one of the circuit and the processor is configured to cause the automatic guided vehicle to:
select only one detection range in case where there is the only one detection range acquired when the automatic guided vehicle is instructed to travel straight.

7. A non-transitory computer readable storage medium storing a computer program for an automatic guided vehicle to travel along a strip-shaped magnetic line on a travel path based on detection results of the magnetic line by a plurality of magnetic sensors arranged in a lateral direction of the automatic guided vehicle and comprising instructions configured to, when executed by a computer, cause the computer to:
acquire a detection range in which the magnetic sensors that have detected the magnetic line are continuous;
select one detection range predicted to correspond to the magnetic line extending in a straight-ahead direction of the automatic guided vehicle, among a plurality of detection ranges acquired when the automatic guided vehicle is instructed to travel straight; and
control a driving state of the automatic guided vehicle so that a center of the one detection range in the lateral direction is brought closer to a center of the automatic guided vehicle in the lateral direction.

8. A method implemented by a processor to control an automatic guided vehicle to travel along a magnetic line on a travel path based on detection results of the magnetic line by a plurality of magnetic sensors arranged in a lateral direction of the automatic guided vehicle, comprising:
acquiring a detection range in which the magnetic sensors that have detected the magnetic line are continuous;
selecting one detection range predicted to correspond to the magnetic line extending in a straight-ahead direction of the automatic guided vehicle, among a plurality of detection ranges acquired when the automatic guided vehicle is instructed to travel straight; and
controlling a driving state of the automatic guided vehicle so that a center of the one detection range in the lateral direction is brought closer to a center of the automatic guided vehicle in the lateral direction.
